(19) United States
(12) Patent Application Publication
(10) Pub. No.: US 2025/0386021 A1
(43) Pub. Date: Dec. 18, 2025

(54) CHROMA MULTIPLE TRANSFORM SELECTION

(71) Applicant: InterDigital CE Patent Holdings, SAS., Paris (FR)

(72) Inventors: Karam Naser, Mouazé (FR); Thierry Dumas, Rennes (FR); Edouard Francois, Bourg des Comptes (FR); Franck Galpin, Thorigne-Fouillard (FR)

(73) Assignee: InterDigital CE Patent Holdings, SAS., Paris (FR)

(21) Appl. No.: 18/878,509

(22) PCT Filed: Jun. 28, 2023
(86) PCT No.: PCT/EP2023/067600

§ 371 Date: Dec. 23, 2024

(30) Foreign Application Priority Data
Jul. 1, 2022 (EP) 22305970.0

(51) Int. Cl. H04N 19/12; H04N 19/157; H04N 19/176; H04N 19/186; H04N 19/44; H04N 19/61

(52) U.S. Cl. CPC H04N 19/12; H04N 19/157; H04N 19/176; H04N 19/186; H04N 19/44; H04N 19/61

(57) ABSTRACT

Systems, methods, and instrumentalities are disclosed for performing chroma multiple transform selection (MTS). MTS may be enabled for one or more chroma components associated with a video block or video block data. A device may determine a transform index associated with performing MTS on chroma components. A decoder may obtain video block data. The decoder may determine MTS is used for one or more chroma components associated with video block data. The decoder may perform inverse transform using MTS on the chroma components associated with the video block data, for example, to generate chroma prediction residual data. The decoder may decode the video block data based on the chroma prediction residual data. An encoder may be configured to determine that MTS is used for chroma components associated with the video block. The encoder may perform transform using MTS on the one or more chroma components associated with the video block.

### CROSS-REFERENCE TO RELATED APPLICATIONS

The application claims the benefit of European Patent Application Number 22305970.0, filed Jul. 1, 2022, the contents of which are incorporated by reference in their entirety herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, methods, and instrumentalities are disclosed for performing chroma multiple transform selection (MTS). MTS may be enabled for one or more chroma components associated with a video block or video block data. A device (e.g., decoder and/or encoder) may be configured to determine a transform index associated with performing MTS on one or more chroma components (e.g., chroma blocks). A decoder may be configured to obtain video block data. The decoder may be configured to determine that MTS is used for one or more chroma components associated with the video block data. The decoder may be configured to perform inverse transform using MTS on the one or more chroma components associated with the video block data, for example, to generate chroma prediction residual data. The decoder may be configured to decode the video block data based on the chroma prediction residual data. An encoder may be configured to obtain a video block. The encoder may be configured to determine that MTS is used for one or more chroma components associated with the video block. The encoder may be configured to perform transform using MTS on the one or more chroma components associated with the video block. The encoder may be configured to encode the video block.

For example, the MTS transform index used for chroma components (e.g., chroma transform index) may be obtained based on implicit MTS. For example, the MTS transform index used for chroma components (e.g., chroma transform index) may be obtained based on a luma transform index. The chroma transform index may be the same as a luma transform index used for a luma block (e.g., component) associated with the chroma block (e.g., chroma component). The chroma transform index may be derived based on the luma transform index.

Certain intra prediction modes may impact MTS. For example, an intra prediction mode (e.g., cross-component linear model (CCLM), multi-model linear model (MMLM), chroma fusion, etc.) may be determined to be used for the coding block. The chroma transform index may be refrained from being signaled. The device may determine the chroma transform index independent of the luma transform index, for example, based on the determined intra prediction mode and/or based on not receiving a chroma transform index in video data. The device may determine to perform implicit MTS on the chroma block, for example, based on the determined intra prediction mode and/or based on not receiving a chroma transform index in video data. The device may determine to use a default transform, for example, based on the determined intra prediction mode and/or based on not receiving a chroma transform index in video data.

Inter Component Transform (ICT) may affect MTS. For example, the device may determine whether ICT is used for the coding block. The device may receive an MTS index indication associated with chroma block(s). The MTS index indication may be a (e.g., single, unique) MTS index indication (e.g., flag), for example, if ICT is enabled. The MTS index indication may include a first MTS index indication and a second MTS index indication (e.g., separate flags for different chroma components), for example, if ICT is not enabled.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a a system in which various aspects and examples may be implemented.

FIG. 6 illustrates an example decoder-based MTS performed on chroma components.

FIG. 7 illustrates an example encoder-based MTS performed on chroma components.

### DETAILED DESCRIPTION

A more detailed understanding may be had from the following description, given by way of example in conjunction with the accompanying drawings.

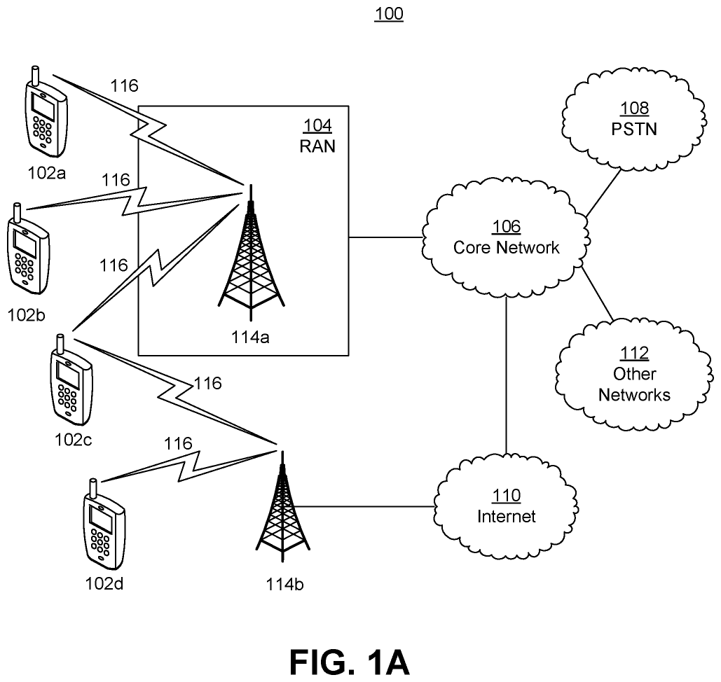

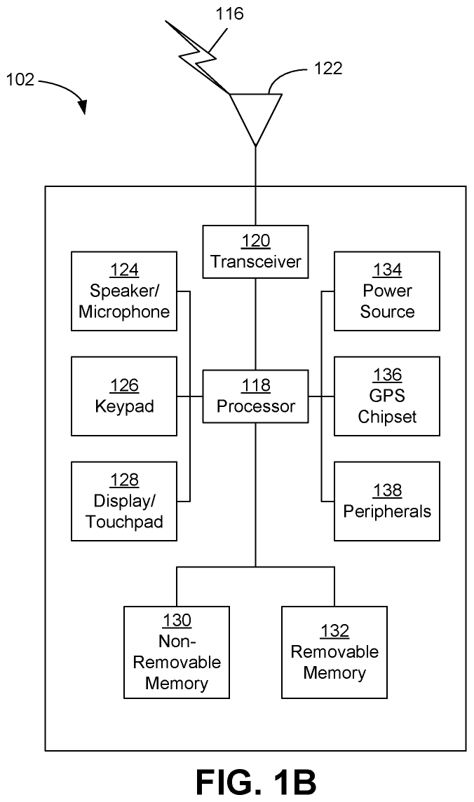

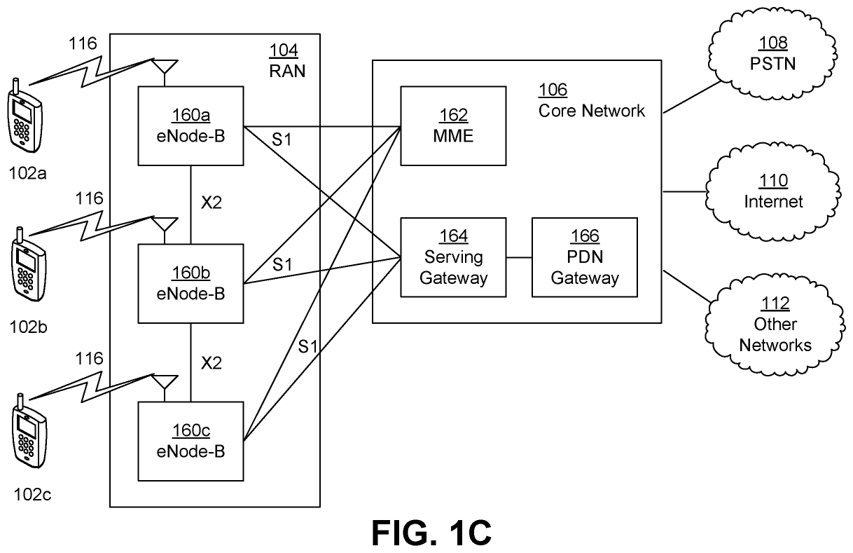

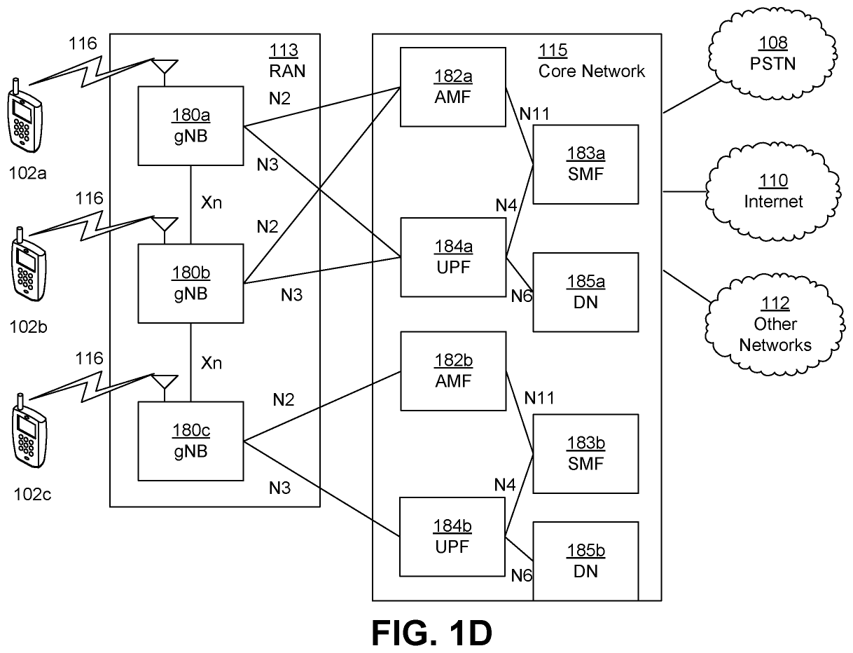

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHZ wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

The aspects described and contemplated in this application may be implemented in many different forms. FIGS. 5-7 described herein may provide some examples, but other examples are contemplated. The discussion of FIGS. 5-7 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

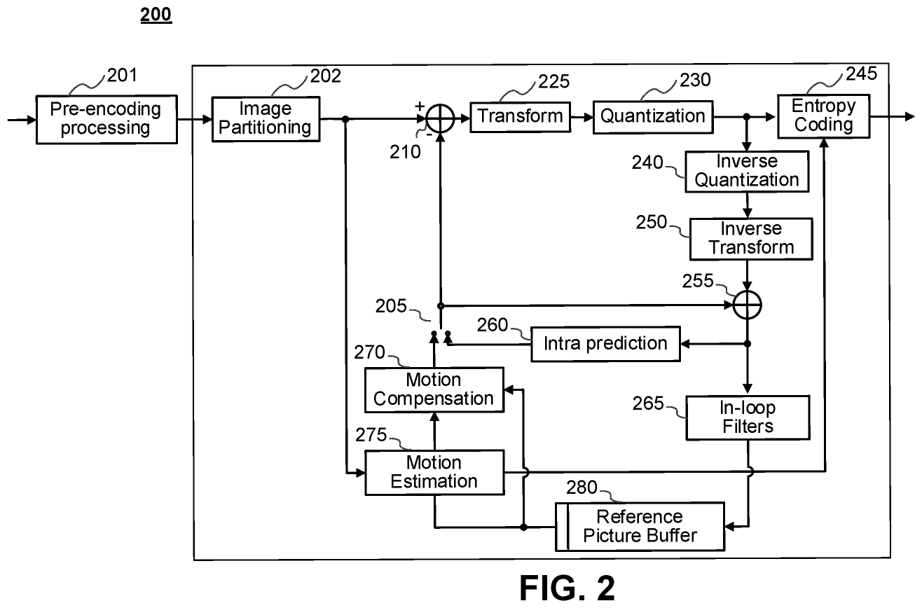

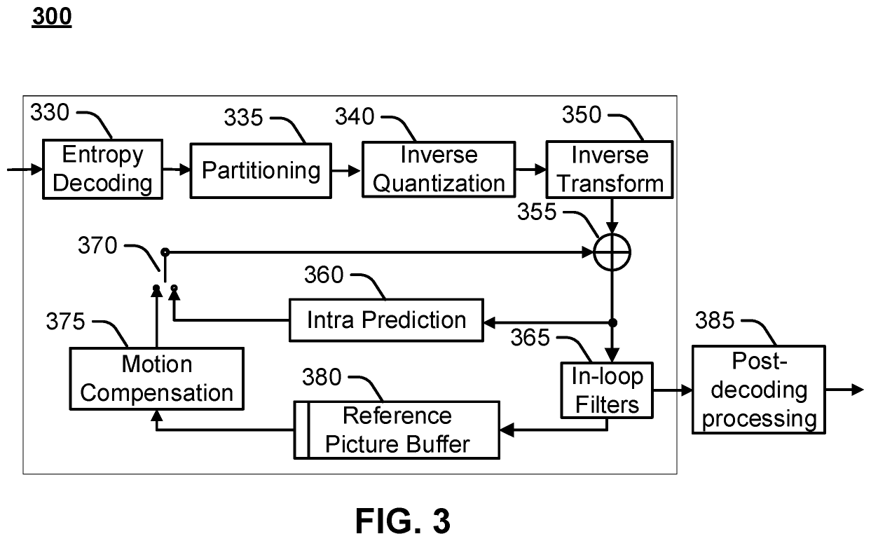

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application. These and other specific values are for purposes of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder may skip the transform and apply quantization directly to the non-transformed residual signal. The encoder may bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture may further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing may use metadata derived in the pre-encoding processing and signaled in the bitstream. In an example, the decoded images (e.g., after application of the in-loop filters (365) and/or after post-decoding processing (385), if post-decoding processing is used) may be sent to a display device for rendering to a user.

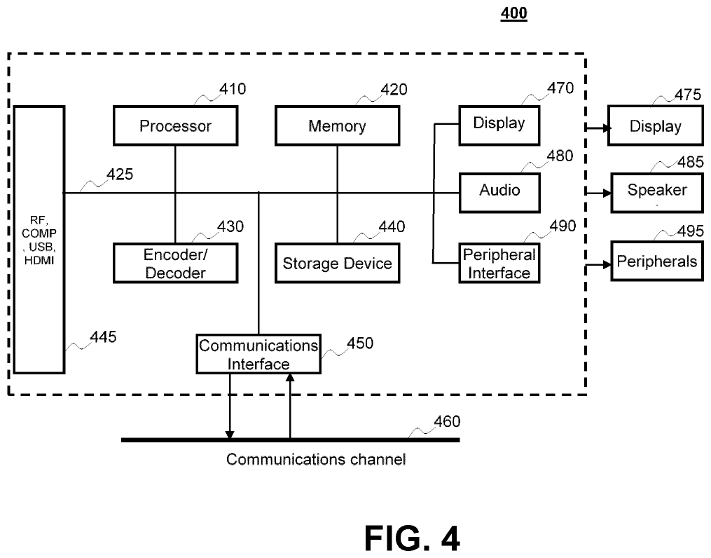

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 may include embedded memory, input output interface, and various other circuitries as known in the art. The system 400 includes at least one memory 420 (e.g., a volatile memory device, and/or a non-volatile memory device). System 400 includes a storage device 440, which may include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 may include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 may include its own processor and memory. The encoder/decoder module 430 represents module(s) that may be included in a device to perform the encoding and/or decoding functions. As is known, a device may include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 may store one or more of various items during the performance of the processes described in this document. Such stored items may include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements may include inserting elements in between existing elements, such as, for example, inserting amplifiers and an analog-to-digital converter. In various examples, the RF portion includes an antenna.

The USB and/or HDMI terminals may include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (I2C) bus, wiring, and printed circuit boards.

The system 400 includes communication interface 450 that enables communication with other devices via communication channel 460. The communication interface 450 may include, but is not limited to, a transceiver configured to transmit and to receive data over communication channel 460. The communication interface 450 may include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 may provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 may also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 may alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and may encompass one or more of microprocessors, general purpose computers, special purpose computers, and processors based on a multi-core architecture, as non-limiting examples.

Various implementations involve decoding. “Decoding”, as used in this application, may encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, determining that multiple transform selection (MTS) is used for one or more chroma components associated with video block data, performing inverse transform using MTS on one or more chroma components associated with video block data to generate chroma prediction residual data, decoding video block data based on the chroma prediction residual data, etc.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, determining that MTS is used for one or more chroma components associated with a video block, performing transform using MTS on the one or more chroma components associated with the video block, etc.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, coding syntax on a transform index, MTS_CU_flag, MTS_Hor_flag, MTS_Ver_flag, MTS_CU_flag_chroma, MTS_Hor_flag_chroma, MTS_Ver_flag_chroma, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information may include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. In this way, in an example the same parameter is used at both the encoder side and the decoder side. Thus, for example, an encoder may transmit (explicit signaling) a particular parameter to the decoder so that the decoder may use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” may also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g. using a monitor, screen, or other type of display) a resulting image (e.g., an image from residual reconstruction of the video bitstream). The TV, set-top box, cell phone, tablet, or other electronic device may receive a signal including an encoded image and perform decoding.

Systems, methods, and instrumentalities are disclosed for performing chroma multiple transform selection (MTS). MTS may be enabled for one or more chroma components associated with a video block or video block data. A device (e.g., decoder and/or encoder) may be configured to determine a transform index associated with performing MTS on one or more chroma components (e.g., chroma blocks). A decoder may be configured to obtain video block data. The decoder may be configured to determine that MTS is used for one or more chroma components associated with the video block data. The decoder may be configured to perform inverse transform using MTS on the one or more chroma components associated with the video block data, for example, to generate chroma prediction residual data. The decoder may be configured to decode the video block data based on the chroma prediction residual data. An encoder may be configured to obtain a video block. The encoder may be configured to determine that MTS is used for one or more chroma components associated with the video block. The encoder may be configured to perform transform using MTS on the one or more chroma components associated with the video block. The encoder may be configured to encode the video block.

For example, the MTS transform index used for chroma components (e.g., chroma transform index) may be obtained based on implicit MTS. For example, the MTS transform index used for chroma components (e.g., chroma transform index) may be obtained based on a luma transform index. The chroma transform index may be the same as a luma transform index used for a luma block (e.g., component) associated with the chroma block (e.g., chroma component). The chroma transform index may be derived based on the luma transform index.

Certain intra prediction modes may impact MTS. For example, an intra prediction mode (e.g., cross-component linear model (CCLM), multi-model linear model (MMLM), chroma fusion, etc.) may be determined to be used for the coding block. The chroma transform index may be refrained from being signaled. The device may determine the chroma transform index independent of the luma transform index, for example, based on the determined intra prediction mode and/or based on not receiving a chroma transform index in video data. The device may determine to perform implicit MTS on the chroma block, for example, based on the determined intra prediction mode and/or based on not receiving a chroma transform index in video data. The device may determine to use a default transform, for example, based on the determined intra prediction mode and/or based on not receiving a chroma transform index in video data.

Inter Component Transform (ICT) may affect MTS. For example, the device may determine whether ICT is used for the coding block. The device may receive an MTS index indication associated with chroma block(s). The MTS index indication may be a (e.g., single, unique) MTS index indication (e.g., flag), for example, if ICT is enabled. The MTS index indication may include a first MTS index indication and a second MTS index indication (e.g., separate flags for different chroma components), for example, if ICT is not enabled.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

Transform coding associated with chroma components may be performed. Multiple transform selection (MTS) may be enabled for chroma components and/or may be enabled for luma components. Specific adaptation of MTS may be provided (e.g., as described herein).

Multiple transform selection may be performed. MTS may be used (e.g., in addition to DCT-II), for example, for residual coding inter and/or intra coded blocks. MTS may use (e.g., multiple) selected transforms, for example, from the DCT8/DST7. The transform matrices may include DST-VII and DCT-VIII. Table 1 illustrates example basis functions of the selected DST/DCT.

TABLE 1

| Transform Type | Basis function Tᵢ(j), i, j = 0, 1, . . . , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} ) where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 2} )$ |

Transform matrices may be quantized (e.g., more accurately than transform matrices in different applications), for example, in order to keep the orthogonality of the transform matrix. The coefficients (e.g., all the coefficients) may have 10-bit, for example, to keep the (e.g., intermediate) values of the transformed coefficients within the 16-bit range (e.g., after horizontal and after vertical transform).

Enabling indication (e.g., separate enabling indications, separate MTS flags) may be specified at an SPS level for intra and inter (e.g., respectively), for example, in order to control an MTS scheme. An indication (e.g., a CU level flag) may be signaled (e.g., to indicate whether MTS is applied or not), for example, if (e.g., when) MTS is enabled at SPS. MTS may be applied (e.g., only) for luma. The MTS signaling may be skipped, for example, if (e.g., when) one or more of the following conditions are applied: the position of the last (e.g., significant) coefficient for the luma transform block (TB) is less than 1 (e.g., DC only); and/or the last (e.g., significant) coefficient of the luma TB is located inside the MTS zero-out region.

DCT2 may be applied, for example in multiple directions. DCT2 may be applied in both directions, for example, based on the MTS CU flag (e.g., if the MTS CU flag is equal to zero). Other flags (e.g., two other flags) may be (e.g., additionally) signaled (e.g., to indicate the transform type for the horizontal and vertical directions, respectively), for example, if the MTS CU flag is equal to one. Table 2 illustrates an example transform and signaling mapping table. The transform selection for ISP and implicit MTS may be used (e.g., unified), for example, by removing the intra-mode and block-shape dependencies. DST7 may be used (e.g., only used) for both horizontal and vertical transform cores, for example, if the current block is in ISP mode or if the current block is intra block and both intra and inter explicit MTS is enabled (e.g., on). 8-bit primary transform cores may be used, for example, for transform matrix precision. The transform cores (e.g., all the transform cores) used may be kept as the same, for example, including 4-point DCT-2 and DST-7, 8-point, 16-point and 32-point DCT-2. Other transform cores (e.g., including 64-point DCT-2, 4-point DCT-8, 8-point, 16-point, 32-point DST-7 and DCT-8) may use 8-bit primary transform cores.

TABLE 2

| MTS_CU_{—} | MTS_Hor_{—} | MTS_Ver_{—} | Intra/inter | |
|---|---|---|---|---|
| flag | flag | flag | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

High frequency transform coefficients may be zeroed out. High frequency transform coefficients may be zeroed out for the DST-7 and DCT-8 blocks with size (e.g., width, height, or both width and height) equal to 32, for example, to reduce the complexity of large size DST-7 and DCT-8. Coefficients within the 16×16 lower-frequency region (e.g., only coefficients within the 16×16 lower-frequency region) may be retained.

The residual of a block may be coded with transform skip mode. A transform skip flag may be refrained from being signaled (e.g., not signaled), for example, if (e.g., when) the CU level MTS_CU_flag is not equal to zero (e.g., to avoid the redundancy of syntax coding). Implicit MTS transform may be set to a default transform (e.g., DCT2), for example, if (e.g., when) LFNST or MIP is activated for the current CU. The implicit MTS may be enabled, for example, if (e.g., when) MTS is enabled for inter coded blocks.

MTS may be performed and/or enabled.

In some examples, DST7 and DCT8 transform kernels (e.g., only DST7 and DCT8 transform kernels) may be utilized (e.g., for MTS), for example, which may be used for intra and inter coding.

Primary transforms (e.g., additional primary transforms), may be employed. Primary transforms may include DCT5, DST4, DST1, and/or identity transform (IDT). An MTS set may be dependent (e.g., made dependent) on the TU size and/or intra mode information. Different TU sizes (e.g., 16 different TU sizes) may be considered. For a (e.g., each) TU size, multiple different (e.g., 5 different) classes may be considered, for example, depending on intra-mode information. For a (e.g., each) class, multiple (e.g., 1, 4 or 6) different transform pairs may be considered. A number of intra MTS candidates may be adaptively selected (e.g., between 1, 4 and 6 MTS candidates), for example, depending on the sum of absolute value of transform coefficients. The sum may be compared against a threshold (e.g., two fixed thresholds), for example, to determine the (e.g., total) number of allowed MTS candidates. The number of allowed MTS candidates may be determined, for example, based on one or more of the following thresholds: 1 candidate: sum<=th0; 4 candidates: th0<sum<=th1; and 6 candidates: sum>th1.

Multiple classes may be considered (e.g., a total of 80 different classes may be considered). Some of those different classes may (e.g., often) share a transform set (e.g., exactly the same transform set). There may be a number (e.g., 58) less than the total different classes (e.g., less than 80) of unique entries in the resultant LUT.

In examples (e.g., for angular modes), a joint symmetry over TU shape and intra prediction may be considered. A mode i (e.g., i>34) with TU shape AxB may be mapped to the a (e.g., same) class corresponding to the mode j=(68−i) with TU shape BxA. The order of the horizontal and vertical transform kernel may be swapped, for example, for a (e.g., each) transform pair. For example, for a 16×4 block with mode 18 (e.g., horizontal prediction) and a 4×16 block with mode 50 (e.g., vertical prediction), the blocks may be mapped to the same class (e.g., where the vertical and horizontal transform kernels are swapped). In examples (e.g., for the wide-angle modes), a (e.g., nearest) conventional angular mode may be used for the transform set determination. For example, mode 2 may be used for (e.g., all) the modes between −2 and −14. Similarly, mode 66 may be used for mode 67 to mode 80.

Chroma prediction modes may be provided and/or enabled. Intra prediction for chroma components may be performed in regular intra prediction (e.g., Planar, DC or angular) and/or cross component prediction model (CCLM), for example, where the luma samples may be used as a prediction for the chroma components.

For example, a prediction mode using chroma decoder side intra mode derivation (DIMD) may be used. Chroma DIMD may be an extension to luma DIMD, for example, in which the template surrounding the chroma blocks (e.g., Cb and Cr components) may be analyzed to obtain the directionality of the residual (e.g., in addition to the collocated luma blocks) and may (e.g., therefore) derive the intra mode.

For example, a prediction mode using extended CCLM with a multi model linear model (MLMM) (e.g., where the 2 CCLM models are derived with a threshold separating the two models) may be used. A (e.g., one) part of the prediction signal may be generated from the first mode and the second part may be generated from the other model, for example, depending on the pixel values.

For example, a prediction may be performed using Chroma Fusion. The prediction for chroma may include combining the regular intra mode with MMLM mode.

The joint residual coding mode (e.g., JointCbCr) may be used. If (e.g., when) the joint residual coding mode is used, the residual of the chroma components (e.g., Cb and Cr) may be coded together and a single residual may be signaled in the bitstream.

MTS may be enabled for chroma components (e.g., a chroma block associated with a coding block). MTS may be determined to be performed for chroma components. MTS may be performed on chroma components, for example, using an MTS transform index. In examples, MTS transform pair(s) (e.g., MTS transform index) for chroma components, may be determined (e.g., obtained) based on the luma MTS transform pair. FIG. 5 illustrates an example of collocated luma components and chroma components. As shown in FIG. 5, the luma transform index may be used to determine the collocated chroma components. In examples, the MTS transform pair for chroma components may be the same as the luma MTS transform pair.

For example, the (e.g., same) process for deriving the transform pair for luma components may be used for deriving the transform pair for chroma components (e.g., the chroma transform index may be derived based on the luma transform index, as shown in FIG. 5). A transform index syntax element may be signaled, for example, to indicate which of the transform pairs may be used (e.g., for the chroma components). The indication may be signaled at the CU level (e.g., similar to transform pairs signaled for luma components) or other levels (e.g., PU, TU).

In examples, the same indication used to indicate a transform pair to be used for luma components may be used for chroma components. A CU level indication (e.g., flag) for MTS may be used for both luma components and chroma components. This method may also be used for (e.g., limited) single tree coding, for example, because the same tree may be shared between luma and chroma components (e.g., therefore a single indication may be used (e.g., needed) to indicate which transform index is used).

In some examples, separate indications may be signaled for luma and chroma components (e.g., cb and cr). Separate indications may offer (e.g., high) flexibility for selecting different transforms for different components. For example, Table 3 illustrates an example transform and signaling mapping table for chroma component(s).

TABLE 3

| MTS_CU_{—} | MTS_Hor_{—} | MTS_Ver_{—} | Intra/inter | |
|---|---|---|---|---|
| flag_chroma | flag_chroma | flag_chroma | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

In examples, the MTS list of the chroma may be modified by the selected MTS of the luma component. For example, the MTS selected (e.g., from the MTS list of the luma components, such as, for example, Table 2) for the luma component may be placed as the first transform in the chroma MTS list (e.g., at the row in Table 3 where MTS_Hor_flag_chroma=0 and MTS_Ver_flag_chroma=0). The signaling may be reduced (e.g., only 0,0 is signaled), for example, if (e.g., when) there is a good correlation between the luma and chroma transforms.

In examples, if (e.g., when) the MTS selected for the luma component is put as the first transform in the chroma MTS list, the other transform pairs in the chroma MTS list may be shifted down in the MTS list. For example (e.g., with respect to Table 2), if the transform pair DST7 and DCT8 is selected for horizontal and vertical respectively for the luma component, the chroma MTS list may be modified by placing DST7 and DCT8 at the row where MTS_Hor_flag_chroma is 0 and MTS_Ver_flag_chroma is 0. As a result, the transform pair where DST7 is for horizontal and DST7 is for vertical may be shifted to the row where MTS_Hor_flag_chroma is 0 and MTS_Ver_flag_chroma is 1, and the transform pair where DCT8 is for horizontal and DST 7 is for vertical may be shifted to the row where MTS_Hor_flag_chroma is 1 and MTS_Ver_flag_chroma is 0. For example (e.g., with respect to Table 3), if the transform pair DST7 and DCT8 is selected for horizontal and vertical respectively for the luma component, the chroma MTS list may swap the transform pair where MTS_Hor_flag_chroma is 0 and MTS_Ver_flag_chroma is 0 (e.g., transform pair DST7 for horizontal and DST7 for vertical), so the chroma MTS list may have transform pair DST7 for horizontal and DCT8 at the row where MTS_Hor_flag_chroma is 0 and MTS_Ver_flag_chroma is 0 and may have transform pair DST7 for horizontal and DST7 for vertical at the row where MTS_Hor_flag_chroma is 1 and MTS_Ver_flag_chroma is 0. The other transform pairs in the chroma MTS list may be unchanged (e.g., the row where MTS_Hor_flag_chroma is 0 and MTS_Ver_flag_chroma is 1 is still mapped to transform pair DCT8 for horizontal and DST7 for vertical, and the row where MTS_Hor_flag_chroma is 1 and MTS_Ver_flag_chroma is 1 is still mapped to DCT8 for horizontal and DCT8 for vertical).

The procedures (e.g., methods, as described herein) may be extended to the dual tree coding. For example, the MTS of the luma component may be taken at the collocated CU of the top-left corner of the chroma block. In examples, the value may be taken at the block center.

Implicit MTS may be enabled and/or performed, for example, for chroma components. For example, implicit MTS may be performed according to Eqs. 1 and 2:

$$trTypeHor = ( nTbW \geq 4 \&\& nTbW \leq 16 ) ? DST 7 : DCT 2 \qquad Eq . 1$$

$$trTypeVer = ( nTbH \geq 4 \&\& nTbH \leq 16 ) ? DST 7 : DCT 2 \qquad Eq . 2$$

Implicit transform selection may be used, for example, instead of signaling an indication describing the selected chroma transform pairs. For a chroma block, the transform pairs may be deduced to be those corresponding to implicit MTS. Implicit MTS may include determining an MTS transform index (e.g., MTS chroma transform index) associated with one or more chroma components, for example, based on a block width and/or a block height associated with a video block. For example, a chroma transform index (e.g., MTS transform index) may be obtained based on performing implicit MTS, for example, where a transform or inverse transform using MTS is performed using the chroma transform index. Using implicit MTS may reduce complexity (e.g., the encoder complexity), for example, as at the encoder side RD search may be refrained from being performed (e.g., not be required) to obtain the (e.g., best) transform index, and also signaling may be refrained from being performed (e.g., may not be required) to describe the selected transform pairs.

Special modes may be used for MTS (e.g., in addition to the other procedures as described herein).

Chroma intra prediction modes (e.g., come chroma intra prediction modes) may be distinctive from the luma intra prediction modes, such as, for example, CCLM/MMLM and/or chroma fusion. Intra prediction modes used for a coding block may be determined. The intra prediction modes may affect performing MTS transform and MTS inverse transform on chroma components. For example, whether to obtain a chroma transform index (e.g., MTS transform index) may be determined based on the determined intra prediction mode.

In some modes (e.g., CCLM/MMLM and/or chroma fusion), luma to chroma prediction may be used. The residual signal corresponding to those signals may be distinctive from the residual signals generated by regular intra prediction. The transform design of these residuals may be different (e.g., cannot follow the same used for luma). One or more of the following may be performed, for example, if the transform design of the residuals from the luma component are different from the residuals from the chroma component: if the chroma component is coded with CCLM/MMLM or chroma fusion mode, the transform index may be refrained from being signaled (e.g., may not be signaled) and a default transform may be used (e.g., DCT-II); if the chroma component is coded with CCLM/MMLM or chroma fusion mode, the transform index may be refrained from being signaled (e.g., may not be signaled) and implicit MTS may be used. The chroma transform index may be determined independent of the luma transform index.

In examples, inter-component transform may be performed (e.g., in a special case of ICT). Inter-Component Transform (ICT) may include a pre-transform, for example, which may use (e.g., exploit) the correlations between the Cb and Cr color components. In examples (e.g., on the encoder side), for a given pair of a Cb coding block (CB) and a Cr CB to be encoded, once the Cb residue generated by subtracting the prediction of the Cb CB from the original Cb CB and the Cr residue generated by subtracting the prediction of the Cr CB from the original Cr CB are obtained, ICT may include applying a rotational transform to the two residues, for example, which may yield a (e.g., single) ICT residue. The (e.g., single) ICT residue may be further encoded, e.g., by applying the DCT2-DCT2. In examples (e.g., on the decoder side), for the given pair of Cb CB and Cr CB to be decoded, once the single reconstructed residue is obtained, the inverse ICT may be applied to it, for example, which may yield the reconstructed Cb residue and the reconstructed Cr residue.

A video device may determine whether ICT is used for a coding block. For example, an indication whether to perform ICT may be signaled. A (e.g., unique, single, one) MTS indication (e.g., MTS index indication) may be signaled for the encoding/decoding of the Cb component and the Cr component (e.g., one MTS index indication used for both a first chroma block and a second chroma block), for example, if (e.g., when) ICT is selected to encode/decode the current pair of a Cb coding block (CB) and a Cr CB. In examples, multiple (e.g., two separate) MTS flags may be signaled for the encoding/decoding of the Cb component and the Cr component, for example, if (e.g., when) ICT is refrained from being used (e.g., not selected) to encode/decode the current pair of a Cb CB and Cr CB (e.g., a first MTS index indication may be used for a first chroma block and a second MTS index indication may be used for a second chroma block). This may enable (e.g., offer) flexibility for selecting the (e.g., best) MTS transform for each chroma component, for example, while deactivating this high flexibility in the case where ICT is selected.

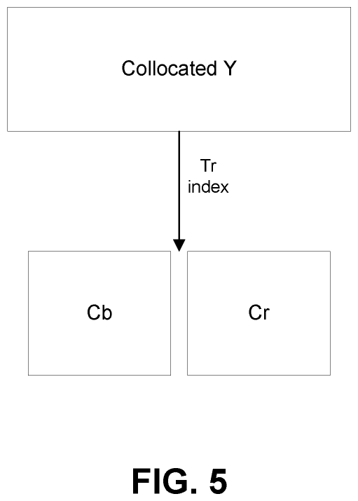

FIG. 6 illustrates an example decoder-based MTS performed on chroma components. As shown at 610 in FIG. 6, video block data may be obtained. As shown at 620 in FIG. 6, MTS may be determined to be used for one or more chroma components associated with the video block data. As shown at 630 in FIG. 6, inverse transform may be performed using MTS on the one or more chroma components associated with the video block data, for example, to generate chroma prediction residual data. As shown at 640 in FIG. 6, the video block data may be decoded, for example, based on the chroma prediction residual data.

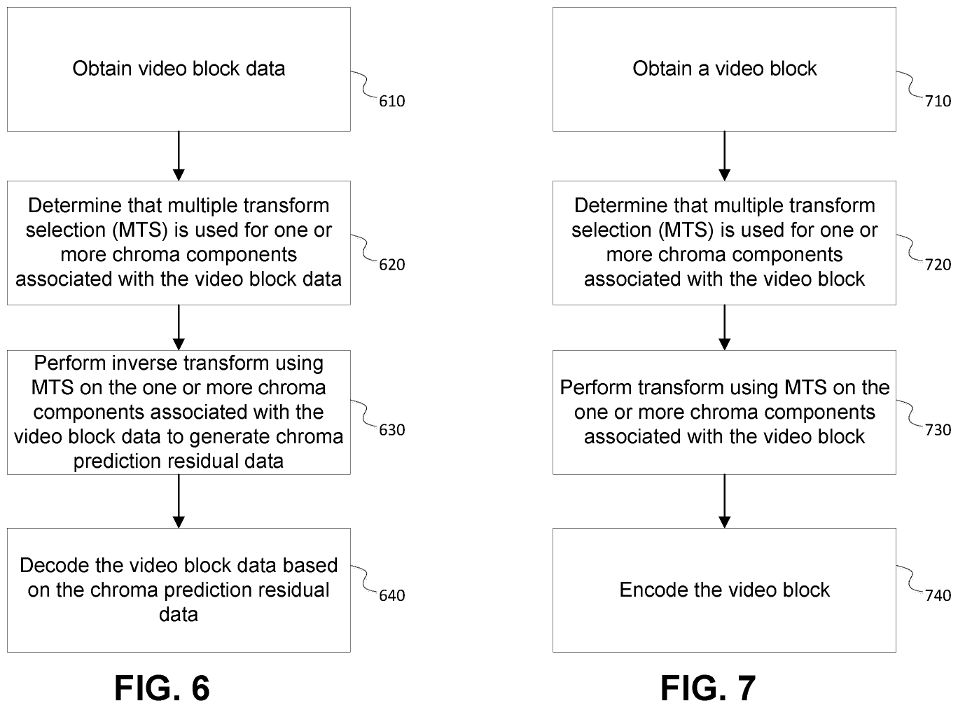

FIG. 7 illustrates an example encoder-based MTS performed on chroma components. As shown at 710, a video block may be obtained. As shown at 720 in FIG. 7, MTS may be determined to be used for one or more chroma components associated with the video block. As shown at 730 in FIG. 7, a transform may be performed using MTS on the one or more chroma components associated with the video block. As shown at 740 in FIG. 7, the video block may be encoded.

In examples, a medium, such as video data, may include information associated with performing MTS on chroma components. A bitstream may include information associated with performing MTS on chroma components. Video data and/or bitstream may comprise information (e.g., for transmission). The video data and/or bitstream may be generated by a device (e.g., encoding device and/or decoding device). The video data and/or bitstream may be stored and/or accessed, for example, for use for MTS on chroma components. The video data and/or bitstream may be transmitted (e.g., to a decoder), for example, to be used for MTS on chroma components. The video data and/or bitstream may or may not be transmitted.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-48 (canceled)

49. A video decoding device comprising:
a processor configured to:
determine whether multiple transform selection (MTS) is used for a chroma block associated with video block data;
determine whether to obtain a chroma transform index, wherein based on a determination that MTS is used for the chroma block, the chroma transform index is determined to be obtained based on a luma transform index that corresponds to the chroma block;
obtain chroma prediction residual data, wherein based on the determination that MTS is used for the chroma block, the chroma prediction residual data is generated based on a performed inverse transform using MTS on the chroma block using the chroma transform index; and
decode the video block data based on the chroma prediction residual data.

50. The video decoding device of claim 49, wherein the chroma transform index obtained based on the luma transform index is the same as the luma transform index.

51. The video decoding device of claim 49, wherein the chroma transform index obtained based on the luma transform index is further obtained based on implicit MTS.

52. The video decoding device of claim 49, wherein the chroma block is associated with a coding block, and wherein the processor is further configured to:
determine an intra prediction mode to be used for the coding block, wherein the determination whether to obtain the chroma transform index is based on the determined intra prediction mode to be used for the coding block.

53. The video decoding device of claim 52, wherein based on the intra prediction mode to be used for the coding block being associated with one of a cross-component linear model (CCLM), a multi- model linear model (MMLM), or chroma fusion, the chroma transform index is determined to be obtained based on implicit MTS.

54. The video decoding device of claim 52, wherein based on the intra prediction mode to be used for the coding block being associated with one of a cross-component linear model (CCLM), a multi-model linear model (MMLM), or chroma fusion, the chroma transform index is determined to be obtained independent of the luma transform index.

55. The video decoding device of claim 52, wherein based on the intra prediction mode to be used for the coding block being associated with one of a cross-component linear model (CCLM), a multi-model linear model (MMLM), or chroma fusion, MTS is determined to be disabled for the chroma block, wherein the chroma prediction residual data is generated based on a performed inverse transform using a default transform.

56. The video decoding device of claim 49, wherein the processor is further configured to:
determine whether inter-component transform (ICT) is used for the chroma block associated with the chroma block;
based on a determination that ICT is used for the chroma block, receive an MTS indication associated with the chroma block, wherein the inverse transform using MTS is performed based on the MTS indication; and
based on a determination that ICT is refrained from being used for the chroma block, receive a first MTS indication and a second MTS indication, wherein the first MTS indication is associated with a first chroma component corresponding to the chroma block, wherein the second MTS indication is associated with a second chroma component corresponding to the chroma block, and wherein the inverse transform using MTS is performed based on the first MTS indication and the second MTS indication.

57. A video encoding device comprising:
a processor configured to:
determine whether multiple transform selection (MTS) is used for a chroma block associated with video block data;
determine whether to obtain a chroma transform index, wherein based on a determination that MTS is used for the chroma block, the chroma transform index is determined to be obtained based on a luma transform index that corresponds to the chroma block;
obtain chroma prediction residual data, wherein based on the determination that MTS is used for the chroma block, the chroma prediction residual data is generated based on a performed transform using MTS on the chroma block using the chroma transform index;
encode the video block data based on the chroma prediction residual data; and
include in video data the encoded video block data and an MTS indication that indicates whether MTS is used for the chroma block.

58. The video encoding device of claim 57, wherein the chroma transform index obtained based on the luma transform index is the same as the luma transform index.

59. The video encoding device of claim 57, wherein the chroma transform index obtained based on the luma transform index is further obtained based on implicit MTS.

60. The video encoding device of claim 57, wherein the chroma block is associated with a coding block, and wherein the processor is further configured to:
determine an intra prediction mode to be used for the coding block, wherein the determination whether to obtain the chroma transform index is based on the determined intra prediction mode to be used for the coding block.

61. The video encoding device of claim 60, wherein based on the intra prediction mode to be used for the coding block being associated with one of a cross-component linear model (CCLM), a multi-model linear model (MMLM), or chroma fusion, the chroma transform index is determined to be obtained based on implicit MTS.

62. The video encoding device of claim 60, wherein based on the intra prediction mode to be used for the coding block being associated with one of a cross-component linear model (CCLM), a multi- model linear model (MMLM), or chroma fusion, the chroma transform index is determined to be obtained independent of the luma transform index.

63. The video encoding device of claim 60, wherein based on the intra prediction mode to be used for the coding block being associated with one of a cross-component linear model (CCLM), a multi-model linear model (MMLM), or chroma fusion, MTS is determined to be disabled for the chroma block, wherein the chroma prediction residual data is generated based on a performed transform using a default transform.

64. The video encoding device of claim 9, wherein the MTS indication is a first MTS indication, and wherein the processor is further configured to:
determine whether inter-component transform (ICT) is used for the chroma block;
based on a determination that ICT is used for the chroma block, receive an MTS indication associated with the chroma block, wherein the transform using MTS is performed based on the first MTS indication; and
based on a determination that ICT is refrained from being used for the chroma block, receive a second MTS indication and a third MTS indication, wherein the second MTS indication is associated with a first chroma component corresponding to the chroma block, wherein the third MTS indication is associated with a second chroma component corresponding to the chroma block, and wherein the transform using MTS is performed based on the first MTS indication and the second MTS indication.

65. A video decoding method comprising:
determining whether multiple transform selection (MTS) is used for a chroma block associated with video block data;
determining whether to obtain a chroma transform index, wherein based on a determination that MTS is used for the chroma block, the chroma transform index is determined to be obtained based on a luma transform index that corresponds to the chroma block;
obtaining chroma prediction residual data, wherein based on the determination that MTS is used for the chroma block, the chroma prediction residual data is generated based on a performed inverse transform using MTS on the chroma block using the chroma transform index; and
decoding the video block data based on the chroma prediction residual data.

66. The video decoding method of claim 65, wherein the chroma transform index obtained based on the luma transform index is the same as the luma transform index or obtained based on implicit MTS.

67. The video decoding method of claim 65, wherein the chroma block is associated with a coding block, and wherein method further comprises:
determining an intra prediction mode to be used for the coding block, wherein the determination whether to obtain the chroma transform index is based on the determined intra prediction mode to be used for the coding block, wherein based on the intra prediction mode to be used for the coding block being associated with one of a cross-component linear model (CCLM), a multi-model linear model (MMLM), or chroma fusion, the chroma transform index is determined to be obtained based on implicit MTS or based independent of the luma transform index.

68. The video decoding method of claim 67, wherein based on the intra prediction mode to be used for the coding block being associated with one of a cross-component linear model (CCLM), a multi-model linear model (MMLM), or chroma fusion, MTS is determined to be disabled for the chroma block, wherein the chroma prediction residual data is generated based on a performed inverse transform using a default transform.
